(19) United States
(12) Patent Application Publication
(10) Pub. No.: US 2009/0015197 A1
(43) Pub. Date: Jan. 15, 2009

(54) POWER TRANSMISSION DEVICE AND ELECTRONIC INSTRUMENT

(75) Inventors: Haruhiko SOGABE, Chino-shi (JP); Kota ONISHI, Nagoya-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/171,922

(22) Filed: Jul. 11, 2008

(30) Foreign Application Priority Data
Jul. 13, 2007 (JP) 2007-183947

(51) Int. Cl. H02J 7/00

(52) U.S. Cl. 320/108

(57) ABSTRACT

A power transmission device includes a resonant capacitor that forms a series resonant circuit with a primary coil, a first power transmission driver and a second power transmission driver that drive the primary coil, and a control IC that outputs driver control signals to the first and second power transmission drivers. The resonant capacitor, the first and second power transmission drivers, and the control IC are provided on a substrate. An output terminal that outputs the driver control signal to the first transmission driver is provided on a first side of the control IC, an output terminal that outputs the driver control signal to the second transmission driver is provided on a second side of the control IC, and an input terminal that receives a signal waveform at one of coil connection terminals through a waveform detection wiring pattern is disposed on a third side of the control IC. The resonant capacitor, the first power transmission driver, and the second power transmission driver are disposed between a first substrate side parallel to the first side of the control IC and the control IC, and the waveform detection wiring pattern extends in an area between a second substrate side and an extension of the third side of the control IC and is connected to one of the coil connection terminals.

Japanese Patent Application No. 2007-183947 filed on Jul. 13, 2007, is hereby incorporated by reference in its entirety.

### BACKGROUND

The present invention relates to a power transmission device that performs non-contact power transmission, an electronic instrument, and the like.

In recent years, non-contact power transmission (contactless power transmission) that utilizes electromagnetic induction to enable power transmission without metal-to-metal contact has attracted attention. As application examples of non-contact power transmission, charging a portable telephone, a household appliance (e.g., telephone handset), and the like have been proposed.

JP-A-2006-60909 discloses related-art non-contact power transmission. In JP-A-2006-60909, a series resonant circuit is formed using a resonant capacitor connected to the output of a power transmission driver and a primary coil so that power is supplied from a power transmission device (primary side) to a power reception device (secondary side).

A large high-frequency alternating analog current of about several hundreds of mA to 1 A flows through a power circuit (e.g., primary coil, resonant capacitor, and transmission driver) of the power transmission device, for example. On the other hand, a weak digital signal or analog signal flows through an IC that controls the power circuit and its peripheral circuit. Therefore, the power circuit of the power transmission device cannot be appropriately controlled without reducing an adverse effect due to a large analog current.

### SUMMARY

According to one aspect of the invention, there is provided a power transmission device that includes a primary coil and electromagnetically couples the primary coil with a secondary coil of a power reception device to supply power to a load of the power reception device, the power transmission device comprising:
coil connection terminals respectively connected to ends of the primary coil;
a resonant capacitor that forms a series resonant circuit with the primary coil;
a first power transmission driver and a second power transmission driver that drive the primary coil from the ends of the primary coil through the coil connection terminals; and
a control IC that outputs driver control signals to the first power transmission driver and the second power transmission driver,
the coil connection terminals, the resonant capacitor, the first power transmission driver, the second power transmission driver, and the control IC being provided on a substrate;
the control IC being formed in the shape of a quadrangle that has a first side, a second side, a third side, and a fourth side, a first output terminal that outputs the driver control signal to the first transmission driver being provided adjacent to the first side, a second output terminal that outputs the driver control signal to the second transmission driver being provided adjacent to the second side crossing the first side, and an input terminal that receives a signal waveform at one of the coil connection terminals through a waveform detection wiring pattern being disposed adjacent to the third side opposite to the second side;
the resonant capacitor, the first power transmission driver, and the second power transmission driver being disposed between a first substrate side and the control IC, the first substrate side being parallel to the first side of the control IC; and
the waveform detection wiring pattern extending in an area between a second substrate side parallel to the third side of the control IC and an extension of the third side of the control IC and being connected to one of the coil connection terminals.

According to another aspect of the invention, there is provided an electronic instrument comprising the above power transmission device.

### BRIEF DESCRIPTION OF THE DRAWINGS

FIGS. 1A and 1B are views illustrative of non-contact power transmission.

FIG. 2 is a view showing a configuration example of a power transmission device, a power transmission control device, a power reception device, and a power reception control device according to one embodiment of the invention.

FIGS. 3A and 3B are views illustrative of data transmission by means of frequency modulation and load modulation.

FIG. 4 is a view showing a configuration example of a power transmission control device according to one embodiment of the invention.

FIGS. 5A and 5B are views illustrative of the tan δ value of a capacitor.

FIG. 6 is a view showing a layout example of a control IC.

FIG. 7 is a view illustrative of two power transmission drivers and a series resonant circuit.

FIG. 8 is an exploded oblique view showing a coil unit.

FIG. 9A is an oblique view showing a coil unit 10 from the front surface, and FIG. 9B is an oblique view showing the coil unit 10 from the back surface.

FIG. 10 is an oblique view showing a substrate from the front surface.

FIG. 11 is an oblique view showing a substrate from the back surface.

FIG. 12 is a view showing the layout of components on a mounting surface of a substrate.

FIG. 13 is a view schematically showing a ground power supply pattern in a control IC.

### DESCRIPTION OF EXEMPLARY EMBODIMENTS

Several aspects of the invention may provide a power transmission device and an electronic instrument that can reduce an adverse effect due to a large analog current by separating a large analog current from a weak analog signal or digital signal.

According to one embodiment of the invention, there is provided a power transmission device that includes a primary coil and electromagnetically couples the primary coil with a secondary coil of a power reception device to supply power to a load of the power reception device, the power transmission device comprising:

coil connection terminals respectively connected to ends of the primary coil;

a resonant capacitor that forms a series resonant circuit with the primary coil;

a first power transmission driver and a second power transmission driver that drive the primary coil from the ends of the primary coil through the coil connection terminals; and

a control IC that outputs driver control signals to the first power transmission driver and the second power transmission driver,

the coil connection terminals, the resonant capacitor, the first power transmission driver, the second power transmission driver, and the control IC being provided on a substrate;

the control IC being formed in the shape of a quadrangle that has a first side, a second side, a third side, and a fourth side, a first output terminal that outputs the driver control signal to the first transmission driver being provided adjacent to the first side, a second output terminal that outputs the driver control signal to the second transmission driver being provided adjacent to the second side crossing the first side, and an input terminal that receives a signal waveform at one of the coil connection terminals through a waveform detection wiring pattern being disposed adjacent to the third side opposite to the second side;

the resonant capacitor, the first power transmission driver, and the second power transmission driver being disposed between a first substrate side and the control IC, the first substrate side being parallel to the first side of the control IC; and

the waveform detection wiring pattern extending in an area between a second substrate side parallel to the third side of the control IC and an extension of the third side of the control IC and being connected to one of the coil connection terminals.

According to one aspect of the invention, the primary coil, the resonant capacitor, the first transmission driver, and the second transmission driver are power circuits. The power circuits through which a high-frequency large analog alternating current flows and the wiring pattern for the driver control signals supplied from the control IC to the first transmission driver and the second transmission driver are collectively disposed on the mounting surface of the substrate. Therefore, a space for forming the waveform detection wiring pattern through which a weak analog signal flows can be provided. This makes it possible to separate a large analog current from a weak analog signal. The control IC includes a waveform detection circuit. The waveform detection circuit monitors the waveform of a signal that corresponds to an induced voltage at one end of the primary coil, and detects a change in load of the secondary-side device (power reception device). This enables data (load) detection, foreign object (metal) detection, detachment (removal) detection, and the like.

In the power transmission device, the resonant capacitor, the first power transmission driver, and the second power transmission driver may be disposed at a position shifted to the control IC side of the extension of the third side of the control IC.

This makes it possible to more advantageously separate a large analog current from a weak analog signal. In one aspect of the invention, the waveform detection wiring pattern may include a wide pattern that is formed along the first substrate side and connected to one of the coil connection terminals, and a narrow pattern that is formed along the first substrate side and connected to the input terminal provided on the third side of the control IC. Even if the waveform detection wiring pattern connected to the control IC is narrow, an adverse effect of a large analog current is reduced due to the wiring layout.

In the power transmission device,

the power transmission device may include power supply patterns provided on a non-mounting surface of the substrate, the non-mounting surface being a back surface of a mounting surface provided with the control IC,

the power supply patterns may include:

a power ground power supply pattern connected to the first power transmission driver and the second power transmission driver; and

an analog ground power supply pattern and a digital ground power supply pattern connected to power supply terminals of the control IC; and

the power ground power supply pattern may be connected to the analog ground power supply pattern and the digital ground power supply pattern only in an area of a ground terminal provided on a third substrate side parallel to the fourth side of the control IC.

It is possible to stabilize the reference potentials of the power circuit, the analog circuit, and the digital circuit due to a reduction in interference by separating the power ground power supply pattern, the analog ground power supply pattern, and the digital ground power supply pattern, as described above.

In the power transmission device,

the power ground power supply pattern may be provided from a first area of the non-mounting surface that is the back surface opposite to a second area where the resonant capacitor, the first power transmission driver, and the second power transmission driver are provided, passing through a third area of the non-mounting surface that is the back surface opposite to a fourth area opposite to the narrow pattern across the control IC, and may be connected to the ground terminal provided on the third substrate side.

The power ground power supply pattern and the analog ground power supply pattern can be separated in this manner.

In the power transmission device,

the power transmission device may include an oscillator that is provided on a mounting surface of the substrate and connected to a terminal provided on the first side of the control IC, and the oscillator may be provided between the first power transmission driver and the first side of the control IC and between the second power transmission driver and the first side of the control IC.

Since the oscillator generates a reference frequency based on which a drive frequency of the power circuit is generated, a serious problem may not occur even if the oscillator is brought close to the power circuit.

The oscillator may be disposed at a first corner side of the control IC, the first corner side including a corner where the first side intersects the third side. According to this configuration, a power supply component disposed at a second corner side of the control IC, the second corner side including a corner where the second side intersects the fourth side. This reduces an adverse effect (e.g., noise) of the oscillator on the power supply component and a power supply voltage supplied from the power supply component to the control IC.

In the power transmission device, the power transmission device may further include a first thermistor that detects a temperature of the primary coil, and a second thermistor that detects an ambient temperature,

the control IC may include a temperature detection circuit that calculates a difference between the temperature of the primary coil from the first thermistor and the ambient temperature from the second thermistor.

The temperature of the primary coil increases when a metal foreign object is present between the primary coil and the secondary coil. An abnormality in power transmission can be detected by comparing the temperature of the primary coil with the ambient temperature.

In the power transmission device,

the power transmission device may further include a first thermistor that detects a temperature of the primary coil, and a second thermistor that detects an ambient temperature,

the control IC may include a temperature detection circuit that detects an abnormality of tan δ of the resonant capacitor by calculating a difference between the temperature of the primary coil from the first thermistor and the ambient temperature from the second thermistor. Specifically, an abnormality in the resonant capacitor that generates heat when an abnormal current flows through the primary coil can be detected based on an abnormality in tan δ.

In the power transmission device,

the control IC may include a control circuit that stops power transmission using the first power transmission driver and the second power transmission driver when the temperature detection circuit has detected an abnormality in temperature. This makes it possible to stop power transmission when a foreign matter such as a metal has been disposed opposite to the primary coil, whereby safety is improved.

According to another embodiment of the invention, there is provided an electronic instrument comprising one of the above power transmission devices.

Preferred embodiments of the invention are described in detail below. Note that the embodiments described below do not in any way limit the scope of the invention defined by the claims laid out herein. Note that all elements of the embodiments described below should not necessarily be taken as essential requirements for the invention.

1. Electronic Instrument

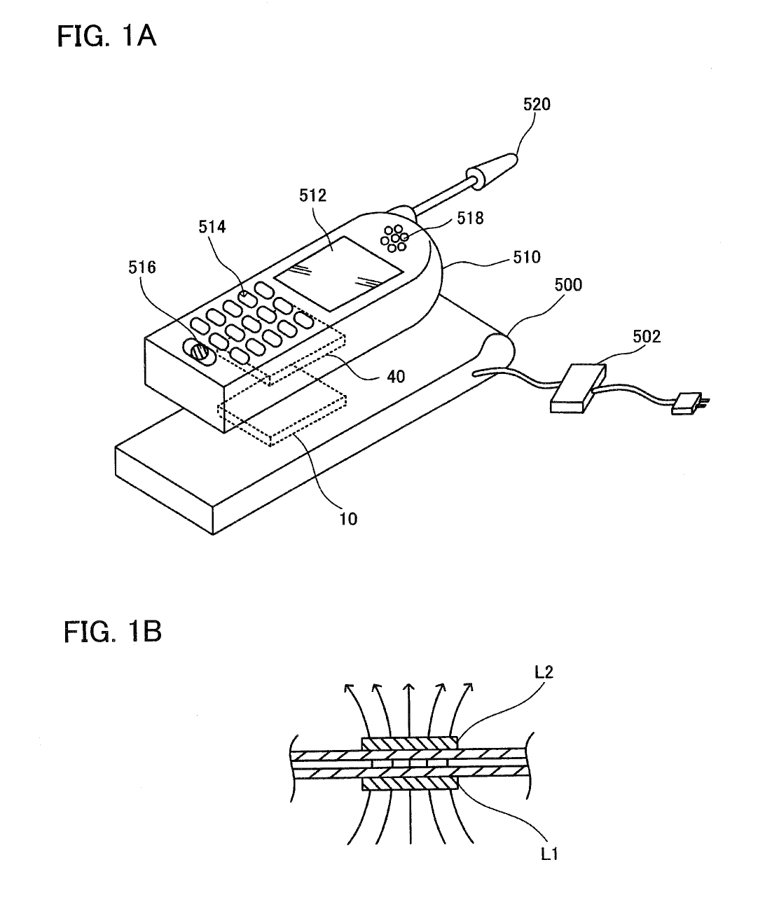

FIG. 1A shows examples of an electronic instrument to which a non-contact power transmission method according to one embodiment of the invention is applied. A charger 500 (cradle) (i.e., electronic instrument) includes a power transmission device 10. A portable telephone 510 (i.e., electronic instrument) includes a power reception device 40. The portable telephone 510 also includes a display section 512 (e.g., LCD), an operation section 514 which includes a button or the like, a microphone 516 (sound input section), a speaker 518 (sound output section), and an antenna 520.

Power is supplied to the charger 500 through an AC adaptor 502. The power supplied to the charger 500 is transmitted from the power transmission device 10 to the power reception device 40 by means of non-contact power transmission. This makes it possible to charge a battery of the portable telephone 510 or operate a device provided in the portable telephone 510.

Note that the electronic instrument to which this embodiment is applied is not limited to the portable telephone 510. For example, this embodiment may be applied to various electronic instruments such as a wristwatch, a cordless telephone, a shaver, an electric toothbrush, a wrist computer, a handy terminal, a portable information terminal, and a power-assisted bicycle.

As schematically shown in FIG. 1B, power transmission from the power transmission device 10 to the power reception device 40 is implemented by electromagnetically coupling a primary coil L1 (power-transmission-side coil) provided in the power transmission device 10 and a secondary coil L2 (power-reception-side coil) provided in the power reception device 40 to form a power transmission transformer. This enables non-contact power transmission.

2. Power Transmission Device and Power Reception Device

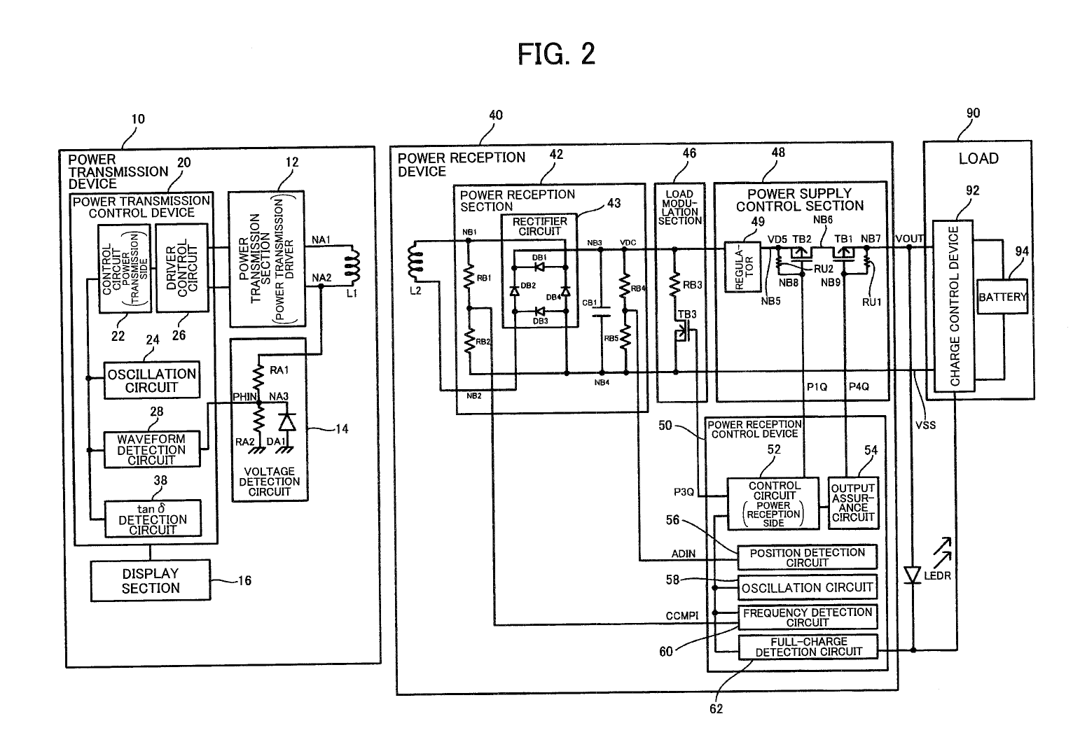

FIG. 2 shows a configuration example of the power transmission device 10, a power transmission control device 20, the power reception device 40, and a power reception control device 50 according to this embodiment. A power-transmission-side electronic instrument such as the charger 500 shown in FIG. 1A includes at least the power transmission device 10 shown in FIG. 2. A power-reception-side electronic instrument such as the portable telephone 510 includes at least the power reception device 40 and a load 90 (actual load). The configuration shown in FIG. 2 implements a non-contact power transmission (contactless power transmission) system in which power is transmitted from the power transmission device 10 to the power reception device 40 by electromagnetically coupling the primary coil L1 and the secondary coil L2, and power (voltage VOUT) is supplied to the load 90 from a voltage output node NB7 of the power reception device 40.

The power transmission device 10 (power transmission module or primary module) may include the primary coil L1, a power transmission section 12, a voltage detection circuit 14, a display section 16, and the power transmission control device 20. The power transmission device 10 and the power transmission control device 20 are not limited to the configuration shown in FIG. 2. Various modifications may be made such as omitting some of the elements (e.g., display section and voltage detection circuit), adding other elements, or changing the connection relationship.

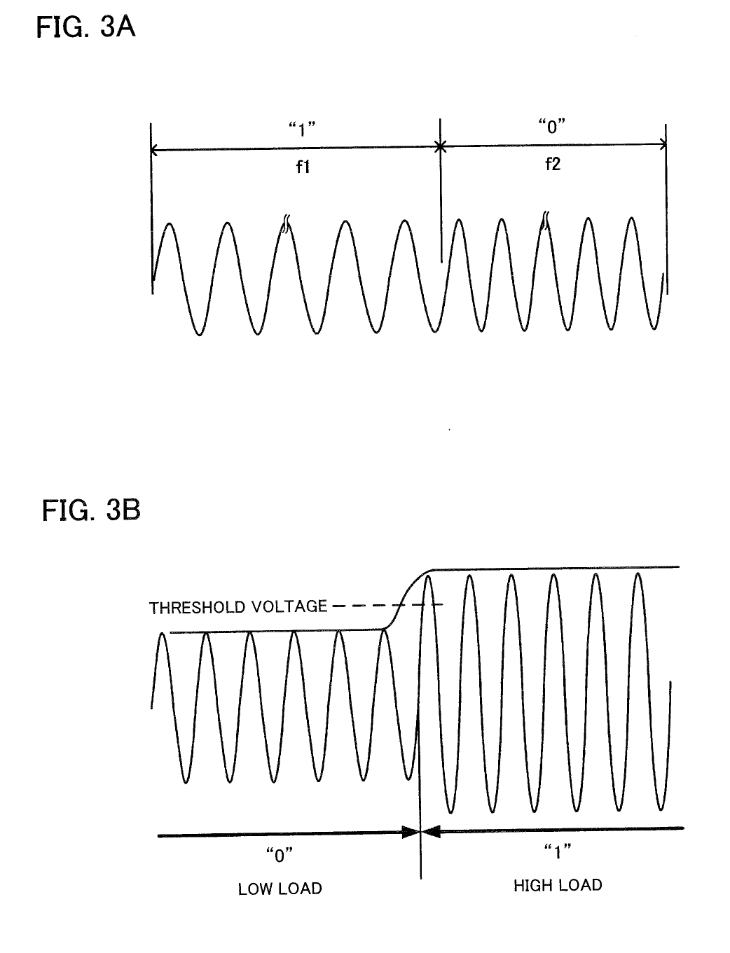

The power transmission section 12 generates an alternating-current voltage at a given frequency during power transmission, and generates an alternating-current voltage at a frequency that differs depending on data during data transfer. The power transmission section 12 supplies the generated alternating-current voltage to the primary coil L1. As shown in FIG. 3A, the power transmission section 12 generates an alternating-current voltage at a frequency f1 when transmitting data “1” to the power reception device 40, and generates an alternating-current voltage at a frequency f2 when transmitting data “0” to the power reception device 40, for example. The power transmission section 12 may include a first power transmission driver that drives one end of the primary coil L1, a second power transmission driver that drives the other end of the primary coil L1, and at least one capacitor that forms a resonant circuit with the primary coil L1.

Each of the first and second power transmission drivers included in the power transmission section 12 is an inverter circuit (buffer circuit) that includes a power MOS transistor, for example, and is controlled by a driver control circuit 26 of the power transmission control device 20.

The primary coil L1 (power-transmission-side coil) is electromagnetically coupled with the secondary coil L2 (power-reception-side coil) to form a power transmission transformer. When power transmission is necessary, the portable telephone 510 is placed on the charger 500 so that a magnetic flux of the primary coil L1 passes through the secondary coil L2, as shown in FIGS. 1A and 1B. When power transmission is unnecessary, the charger 500 and the portable telephone 510 are physically separated so that a magnetic flux of the primary coil L1 does not pass through the secondary coil L2.

The voltage detection circuit 14 is a circuit that detects the induced voltage in the primary coil L1. The voltage detection circuit 14 includes resistors RA1 and RA2 and a diode DA1 provided between a connection node NA3 of the resistors RA1 and RA2 and a power supply GND (first power supply in a broad sense), for example.

The voltage detection circuit 14 functions as a half-wave rectifier circuit for a coil end voltage signal of the primary coil L1. A signal PHIN (induced voltage signal or half-wave rectified signal) obtained by dividing the coil end voltage of the primary coil L1 using the resistors RA1 and RA2 is input to a waveform detection circuit 28 (amplitude detection circuit or pulse width detection circuit) of the power transmission control device 20. Specifically, the resistors RA1 and RA2 form a voltage divider circuit (resistor divider circuit), and the signal PHIN is output from the voltage division node NA3 of the resistors RA1 and RA2.

The display section 16 displays the state (e.g., power transmission or ID authentication) of the non-contact power transmission system using a color, an image, or the like. The display section 16 is implemented by an LED, an LCD, or the like.

The power transmission control device 20 controls the power transmission device 10. The power transmission control device 20 may be implemented by an integrated circuit device (control IC) or the like. The power transmission control device 20 may include a (power-transmission-side) control circuit 22, an oscillation circuit 24, a driver control circuit 26, the waveform detection circuit 28, and a temperature detection circuit (tan δ detection circuit) 38.

The control circuit 22 (control section) controls the power transmission device 10 and the power transmission control device 20. The control circuit 22 may be implemented by a gate array, a microcomputer, or the like. Specifically, the control circuit 22 performs sequence control and a determination process necessary for power transmission, load detection, frequency modulation, foreign object detection, detachment detection, and the like.

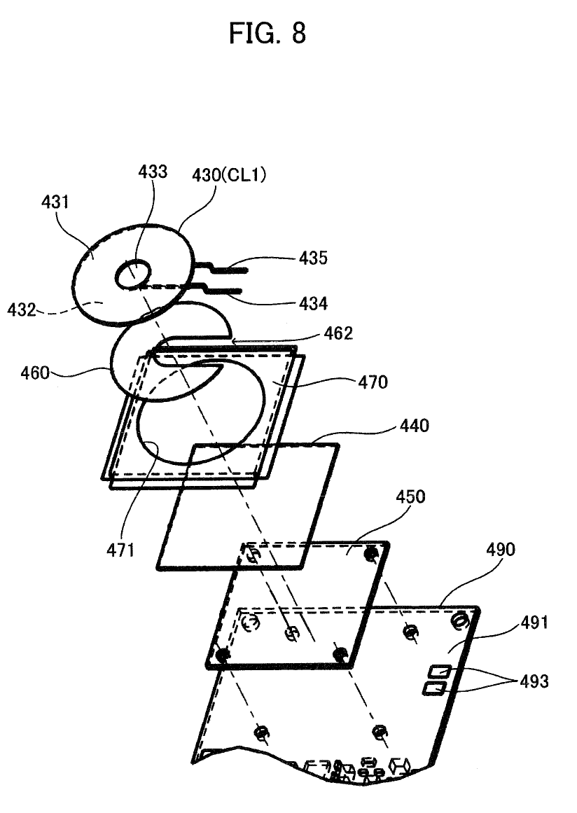

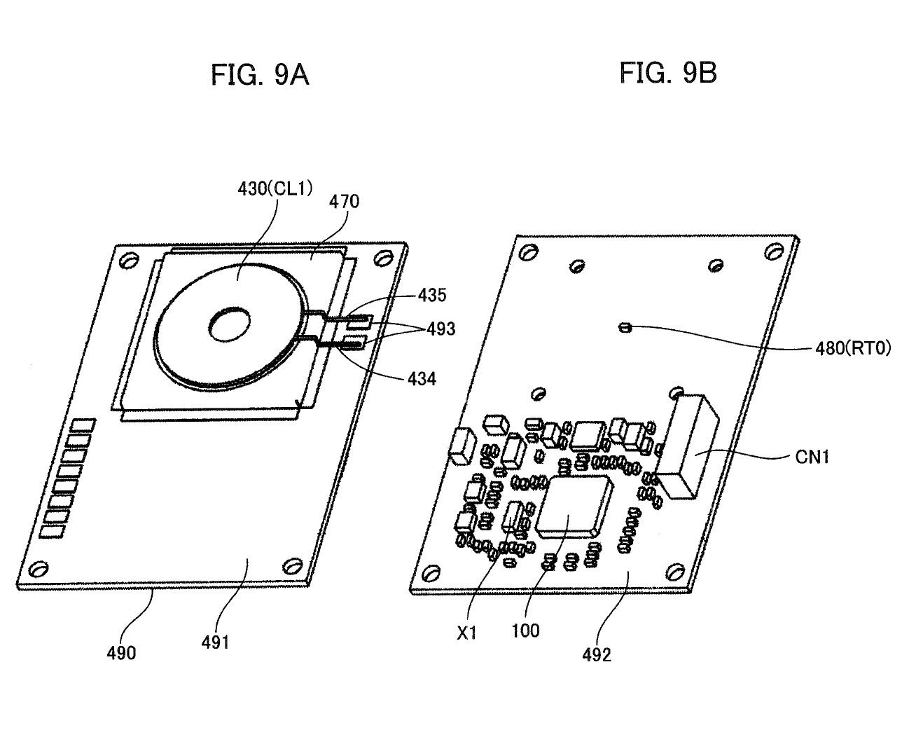

The oscillation circuit 24 includes a crystal oscillation circuit, for example. The oscillation circuit 24 generates a primary-side clock signal based on a reference clock signal from an external oscillator 206 (see FIGS. 8 and 9). The driver control circuit 26 generates a control signal at a desired frequency based on the clock signal generated by the oscillation circuit 24, a frequency setting signal from the control circuit 22, and the like, and outputs the control signal to the first and second power transmission drivers of the power transmission section 12 to control the first and second power transmission drivers.

The waveform detection circuit 28 monitors the waveform of the signal PHIN that corresponds to the induced voltage at one end of the primary coil L1, and detects a change in load on the secondary-side device (power reception device). This enables data (load) detection, foreign object (metal) detection, detachment (removal) detection, and the like. Specifically, the waveform detection circuit 28 (amplitude detection circuit) detects amplitude information (peak voltage, amplitude voltage, and root-mean-square voltage) relating to the signal PHIN that corresponds to the induced voltage at one end of the primary coil L1.

For example, when a load modulation section 46 of the power reception device 40 modulates load in order to transmit data to the power transmission device 10, the signal waveform of the induced voltage in the primary coil L1 changes as shown in FIG. 3B. Specifically, the amplitude (peak voltage) of the signal waveform decreases when the load modulation section 46 reduces load in order to transmit data “0”, and increases when the load modulation section 46 increases load in order to transmit data “1”. Therefore, the waveform detection circuit 28 can determine whether the data from the power reception device 40 is “0” or “1” by determining whether or not the peak voltage has exceeded a threshold voltage as a result of a peak-hold process performed on the signal waveform of the induced voltage, for example.

The load change detection method performed by the waveform detection circuit 28 is not limited to the method shown in FIGS. 3A and 3B. The waveform detection circuit 28 may determine whether the power-reception-side load has increased or decreased using a physical quantity other than the peak voltage. For example, the waveform detection circuit 28 (pulse width detection circuit) may detect pulse width information (pulse width period in which the coil end voltage waveform is equal to or higher than the given setting voltage) relating to the induced voltage signal PHIN of the primary coil L1. Specifically, the waveform detection circuit 28 receives a waveform shaping signal from a waveform adjusting circuit that generates a waveform adjusting signal for the signal PHIN and a drive clock signal from a drive clock signal generation circuit that supplies the drive clock signal to the driver control circuit 26. The waveform detection circuit 28 may detect the pulse width information relating to the induced voltage signal PHIN by detecting pulse width information relating to the waveform adjusting signal to detect a change in load.

The tan δ detection circuit (temperature detection circuit) 38 detects an abnormality (failure) in tan δ of a capacitor used for non-contact power transmission. This capacitor is electrically connected at one end to the output of the power transmission driver of the power transmission section 12, and forms a resonant circuit (series resonant circuit) with the primary coil L1. The control circuit 22 stops power transmission using the power transmission drivers of the power transmission section 12 when an abnormality in tan δ of the capacitor has been detected. Specifically, the tan δ detection circuit 38 detects an abnormality in tan δ of the capacitor by calculating the difference between the capacitor temperature and the ambient temperature. The control circuit 22 stops power transmission from the primary side to the secondary side when determining that the difference between the capacitor temperature and the ambient temperature has exceeded a given temperature difference. The control circuit 22 may stop power transmission from the primary side to the secondary side when determining that the capacitor temperature has exceeded a given temperature.

Another temperature detection circuit may be provided instead of, or in addition to, the tan δ detection circuit 38. The temperature detection circuit detects an abnormality in temperature of the primary coil L1 by comparing the temperature of the primary coil L1 with the ambient temperature. In this case, the control circuit 22 may stop power transmission from the primary side to the secondary side when determining that the difference between the temperature of the primary coil and the ambient temperature has exceeded a given temperature difference.

The power reception device 40 (power reception module or secondary module) may include the secondary coil L2, a power reception circuit (power reception section) 42, a load modulation section 46, a power supply control section 48, and a power reception control device 50. Note that the power reception device 40 and the power reception control device 50 are not limited to the configuration shown in FIG. 2. Various modifications may be made such as omitting some of the elements, adding other elements, or changing the connection relationship.

The power reception section 42 converts an alternating-current induced voltage in the secondary coil L2 into a direct-current voltage. A rectifier circuit 43 included in the power reception circuit 42 converts the alternating-current induced voltage. The rectifier circuit 43 includes diodes DB1 to DB4. The diode DB1 is provided between a node NB1 at one end of the secondary coil L2 and a node NB3 (direct-current voltage VDC generation node). The diode DB2 is provided between the node NB3 and a node NB2 at the other end of the secondary coil L2. The diode DB3 is provided between the node NB2 and a node NB4 (VSS). The diode DB4 is provided between the nodes NB4 and NB1.

Resistors RB1 and RB2 of the power reception circuit 42 are provided between the nodes NB1 and NB4. A signal CCMPI obtained by dividing the voltage between the nodes NB1 and NB4 using the resistors RB1 and RB2 is input to a frequency detection circuit 60 of the power reception control device 50.

A capacitor CB1 and resistors RB4 and RB5 of the power reception circuit 42 are provided between the node NB3 (direct-current voltage VDC) and the node NB4 (VSS). A signal ADIN obtained by dividing the voltage between the nodes NB3 and NB4 using the resistors RB4 and RB5 is input to a position detection circuit 56 of the power reception control device 50.

The load modulation section 46 performs a load modulation process. Specifically, when the power reception device 40 transmits desired data to the power transmission device 10, the load modulation section 46 variably changes the load of the load modulation section 46 (secondary side) depending on transmission data to change the signal waveform of the induced voltage in the primary coil L1 (see FIG. 3B). The load modulation section 46 includes a resistor RB3 and a transistor TB3 (N-type CMOS transistor) provided in series between the nodes NB3 and NB4. The transistor TB3 is ON/OFF-controlled based on a signal P3Q from a control circuit 52 of the power reception control device 50. When modulating load by ON/OFF-controlling the transistor TB3, transistors TB1 and TB2 of the power supply control section 48 are turned OFF so that the load 90 is electrically disconnected from the power reception device 40.

For example, when reducing the secondary-side load (high impedance) in order to transmit data “0”, as shown in FIG. 3B, the signal P3Q is set at the L level so that the transistor TB3 is turned OFF. As a result, the load of the load modulation section 46 becomes almost infinite (no load). On the other hand, when increasing the secondary-side load (low impedance) in order to transmit data “1”, the signal P3Q is set at the H level so that the transistor TB3 is turned ON. As a result, the load of the load modulation section 46 is equivalent to the resistor RB3 (high load).

The power supply control section 48 controls the amount of power supplied to the load 90. A regulator 49 regulates the voltage level of the direct-current voltage VDC obtained by conversion by the rectifier circuit 43 to generate a power supply voltage VD5 (e.g., 5 V). The power reception control device 50 operates based on the power supply voltage VD5 supplied from the power supply control section 48, for example.

A transistor TB2 (P-type CMOS transistor) is controlled based on a signal P1Q from the control circuit 52 of the power reception control device 50. Specifically, the transistor TB2 is turned ON when ID authentication has been completed (established) and normal power transmission is performed, and is turned OFF during load modulation or the like.

A transistor TB1 (P-type CMOS transistor) is controlled based on a signal P4Q from an output assurance circuit 54. Specifically, the transistor TB1 is turned ON when ID authentication has been completed and normal power transmission is performed. The transistor TB1 is turned OFF when connection of an AC adaptor has been detected or the power supply voltage VD5 is lower than the operation lower limit voltage of the power reception control device 50 (control circuit 52), for example.

The power reception control device 50 controls the power reception device 40. The power reception control device 50 may be implemented by an integrated circuit device (IC) or the like. The power reception control device 50 may operate based on the power supply voltage VD5 generated based on the induced voltage in the secondary coil L2. The power reception control device 50 may include the (power-reception-side) control circuit 52, the output assurance circuit 54, the position detection circuit 56, an oscillation circuit 58, the frequency detection circuit 60, and a full-charge detection circuit 62.

The control circuit 52 (control section) controls the power reception device 40 and the power reception control device 50. The control circuit 52 may be implemented by a gate array, a microcomputer, or the like. Specifically, the control circuit 22 performs sequence control and a determination process necessary for ID authentication, position detection, frequency detection, load modulation, full-charge detection, and the like.

The output assurance circuit 54 is a circuit that assures the output from the power reception device 40 when the voltage is low (0 V). The output assurance circuit 54 prevents a backward current flow from the voltage output node NB7 to the power reception device 40.

The position detection circuit 56 monitors the waveform of the signal ADIN that corresponds to the waveform of the induced voltage in the secondary coil L2, and determines whether or not the primary coil L1 and the secondary coil L2 have an appropriate positional relationship. Specifically, the position detection circuit 56 converts the signal ADIN into a binary value using a comparator to determine whether or not the primary coil L1 and the secondary coil L2 have an appropriate positional relationship.

The oscillation circuit 58 includes a CR oscillation circuit, for example. The oscillation circuit 58 generates a secondary-side clock signal. The frequency detection circuit 60 detects the frequency (f1 or f2) of the signal CCMPI, and determines whether the data transmitted from the power transmission device 10 is “1” or “0”, as shown in FIG. 3A.

The full-charge detection circuit 62 (charge detection circuit) is a circuit which detects whether or not a battery 94 (secondary battery) of the load 90 has been fully charged (completely charged).

The load 90 includes a charge control device 92 that controls charging of the battery 94 and the like. The charge control device 92 (charge control IC) may be implemented by an integrated circuit device or the like. The battery 94 may be provided with the function of the charge control device 92 (e.g., smart battery).

3. Detection of Abnormality in Tan δ

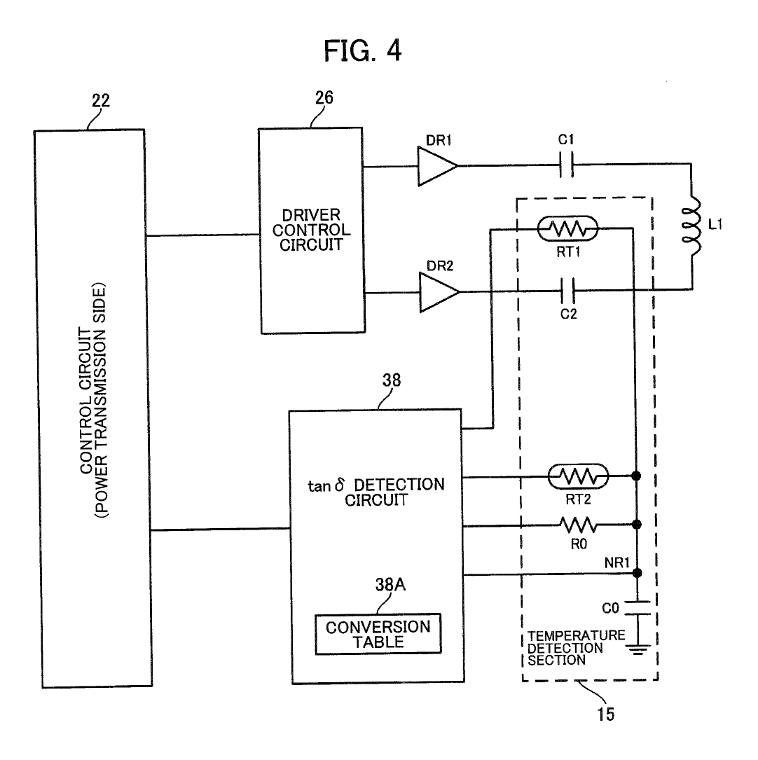

FIG. 4 shows a specific configuration example of the power transmission control device 20 according to this embodiment. In FIG. 4, the driver control circuit 26 generates driver control signals, and outputs the driver control signals to the first and second power transmission drivers DR1 and DR1 that drive the primary coil L1. A capacitor C1 is provided between the output of the power transmission driver DR1 and the primary coil L1, and a capacitor C2 is provided between the output of the power transmission driver DR2 and the primary coil L1. A series resonant circuit is formed by the capacitors C1 and C2 and the primary coil L1. Note that the configuration of the resonant circuit is not limited to the configuration shown in FIG. 4. For example, one of the capacitors C1 and C2 may be omitted.

The tan δ detection circuit 38 (temperature measurement circuit) detects an abnormality (failure) in tan δ of the capacitors C1 and C2. Note that the tan δdetection circuit 38 may detect an abnormality in tan δ of both or one of the capacitors C1 and C2. The control circuit 22 stops power transmission using the power transmission drivers DR1 and DR2 when an abnormality in tan δ has been detected. For example, the control circuit 22 outputs a drive stop signal to the driver control circuit 26, and the driver control circuit 26 stops outputting the driver control signals to the power transmission drivers DR1 and the DR2. Alternatively, the control circuit 22 causes the drive clock signal generation circuit to stop supplying the drive clock signal for the driver control circuit 26 to generate the driver control signals. This causes the power transmission drivers DR1 and the DR2 to stop driving the primary coil L1 so that non-contact power transmission stops.

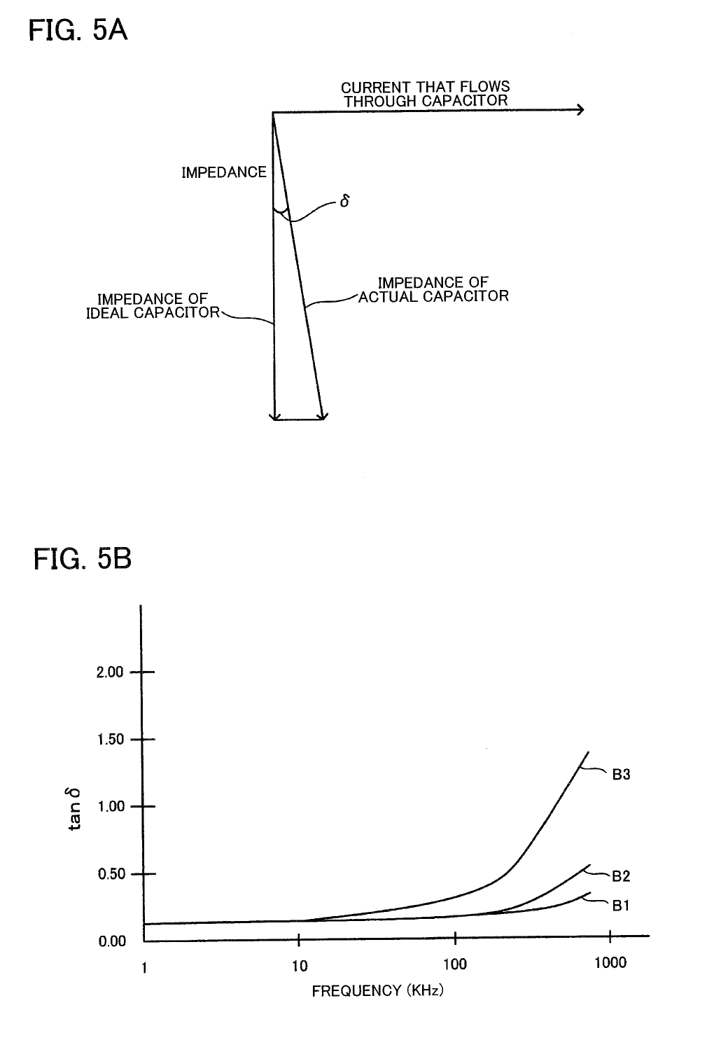

For example, the phase of a sine-wave current which flows through an ideal capacitor is shifted with respect to the phase of the voltage by 90 degrees. On the other hand, the phase shift of an actual capacitor is reduced by an angle δ due to dielectric loss caused by parasitic resistance and the like. As shown in FIG. 5A, an actual capacitor is considered to have a loss corresponding to Zc×tan δ with respect to the impedance (−jZc, Zc=½ pifc) of an ideal capacitor. The capacitor generates heat due to such a loss. tan δ is referred to as a dielectric dissipation factor, which is an important parameter that indicates the performance of a capacitor.

FIG. 5B shows tan δ values measured for capacitors. A symbol B1 indicates a tan δ value measured for a normal product, and symbols B2 and B3 indicate tan δ values measured for abnormal products. An increase in tan δ of the normal product (B1) is small even if the frequency increases. On the other hand, the tan δ of the abnormal products (B2 and B3) increases to a large extent as the frequency increases. For example, a capacitor which has a normal tan δ value before being mounted on a circuit board may have an abnormal tan δ value due to soldering heat or the like during mounting.

The power transmission drivers DR1 and the DR2 shown in FIG. 4 drive the primary coil L1 at a high drive frequency (alternating-current frequency) of 100 to 500 KHz, for example. A large alternating current of about several hundreds of mA to 1 A flows through the primary coil L1 and the resonant capacitors C1 and C2 (a current of several tens of mA flows through other components). Therefore, heat may be generated due to dielectric loss when the capacitor has an abnormal tan δ value, whereby the capacitors C1 and C2 may break.

As shown in FIG. 5B, when the drive frequency is low, a serious problem does not occur even if the capacitor has an abnormal tan δ value. Therefore, an abnormality in tan δ of the capacitor has not been taken into consideration.

However, in order to improve the efficiency and stability of non-contact power transmission and reduce power consumption due to non-contact power transmission, it is desirable to set the drive frequency at a value sufficiently higher than the resonance frequency of the resonant circuit. When the drive frequency is increased to 100 KHz or more, for example, the capacitor may generate heat and break when the capacitor has an abnormal tan δ value.

In order to prevent such a situation, this embodiment employs a method that detects an abnormality in tan δ of the capacitor and stops power transmission from the primary side to the secondary side when an abnormality has been detected. For example, power transmission is stopped when the difference between the capacitor temperature and the ambient temperature has increased or the capacitor temperature has increased (i.e., an abnormality has been detected).

Specifically, a temperature detection section 15 shown in FIG. 4 includes a reference resistor R0, a capacitor temperature measurement thermistor (first thermistor) RT1, and an ambient temperature measurement thermistor (second thermistor) RT2. The thermistor RT1 is disposed near the capacitors C1 and C2, and the thermistor RT2 is disposed at a distance from the capacitors C1 and C2. For example, the reference resistor R0 and the thermistors RT1 and RT2 are provided as external components on a circuit board on which an IC of the power transmission control device 20 is mounted. The thermistor RT1 is provided near the capacitors C1 and C2, and the thermistor RT2 is provided at a distance from the capacitors C1 and C2. The thermistor is a resistor of which the electrical resistance changes to a large extent with respect to a change in temperature.

The tan δ detection circuit 38 measures temperature using a resistance frequency conversion (RF conversion) method. Specifically, the tan δ detection circuit 38 measures the capacitor temperature by calculating first resistance ratio information (first count value or CR oscillation time within reference measurement time) which is resistance ratio information relating to the reference resistor R0 and the capacitor temperature measurement thermistor RT1. The tan δ detection circuit 38 measures the ambient temperature by calculating second resistance ratio information (second count value or CR oscillation time within reference measurement time) which is resistance ratio information relating to the reference resistor R0 and the ambient temperature measurement thermistor RT2. The tan δ detection circuit 38 detects whether or not an abnormality in tan δ of the capacitor has occurred by calculating the difference between the capacitor temperature and the ambient temperature thus measured.

Specifically, the thermistors RT1 and RT2 have a negative temperature coefficient, for example. The resistances of the thermistors RT1 and RT2 decrease as the temperature increases. Therefore, the capacitor temperature and the ambient temperature can be measured by calculating the first resistance ratio information relating to the reference resistor R0 and the thermistor RT1 and the second resistance ratio information relating to the reference resistor R0 and the thermistor RT2. A change in the capacitance of the reference capacitor C0, the power supply voltage, or the like can be absorbed by measuring the temperature based on the resistance ratio of the reference resistor R0 and the thermistor RT1 or RT2, whereby the temperature measurement accuracy can be improved. The above-described configuration of the thermistor may be similarly applied to an element that detects the temperature of the primary coil L1.

When detecting an abnormality in tan δ of the capacitor based only on the capacitor temperature, an abnormality in tan δ may not be detected when the capacitor temperature does not increase due to a low ambient temperature. For example, when the ambient temperature is 5° C. and the capacitor temperature is 30° C., an abnormality in tan δ cannot be detected even though the capacitor generates heat in an amount corresponding to 25° C. Therefore, a capacitor having an abnormal tan δ value is overlooked.

In FIG. 4, an abnormality in tan δ is detected based on the difference between the capacitor temperature and the ambient temperature. For example, when the ambient temperature is 5° C. and the capacitor temperature is 30° C., an abnormality in tan δ is detected since the difference between the capacitor temperature and the ambient temperature is 25° C. Therefore, generation of heat from the capacitor due to an abnormality in tan δ can be detected quickly and reliably independent of the ambient environment so that reliability can be improved. The temperature detection method based on the ambient temperature may be similarly applied to the case of detecting the temperature of the primary coil L1.

The tan δ detection circuit 38 includes a conversion table 38A for converting the resistance ratio information into temperature. The conversion table 38A may be implemented by a memory such as a ROM. The conversion table 38A may also be implemented by a combinational circuit or the like.

The tan δ detection circuit 38 determines the capacitor temperature based on the conversion table 38A and the first resistance ratio information, and determines the ambient temperature based on the conversion table 38A and the second resistance ratio information. Specifically, the tan δ detection circuit 38 reads conversion information for converting the resistance ratio information into temperature from the conversion table 38A, for example, and converts the first resistance ratio information (first count value) into the capacitor temperature or converts the second resistance ratio information (second count value) into the ambient temperature based on the conversion information.

More specifically, the conversion table 38A stores first conversion information (CN) for calculating the number of tens of degrees of the temperature (temperature in units of 10° C.) and second conversion information (AN) for calculating the number of degrees of the temperature (temperature in units of 1° C.) as the conversion information.

The tan δ detection circuit 38 specifies the number of tens of degrees of the temperature corresponding to the first resistance ratio information (first count value) based on the first conversion information stored in the conversion table 38A. The tan δ detection circuit 38 calculates the number of units of the temperature corresponding to the first resistance ratio information by linear interpolation (interpolation calculations) using the second conversion information stored in the conversion table 38A to convert the first resistance ratio information (first count value) into data relating to the capacitor temperature.

The tan δ detection circuit 38 specifies the number of tens of degrees of the temperature corresponding to the second resistance ratio information (second count value) based on the first conversion information stored in the conversion table 38A. Similarly, the tan δ detection circuit 38 calculates the number of units of the temperature corresponding to the second resistance ratio information by linear interpolation (interpolation calculations) using the second conversion information stored in the conversion table 38A to likewise convert the second resistance ratio information (second count value) into data relating to the ambient temperature.

A linear interpolation conversion process can be performed using the conversion table 38A while regarding characteristics within each of a plurality of temperature ranges obtained by dividing the measured temperature range as pseudo linear characteristics, even if the temperature-thermistor resistance conversion characteristics are not linear characteristics. This enables the scale of the tan δ detection circuit 38 to be reduced while simplifying the process performed by the tan δ detection circuit 38. Moreover, a temperature conversion process can be implemented over a wide temperature range (e.g., −30 to 120° C.) by performing linear interpolation within each temperature range. This enables an abnormality in tan δ to be detected over a wide measurement temperature range so that reliability can be improved.

4. Control IC

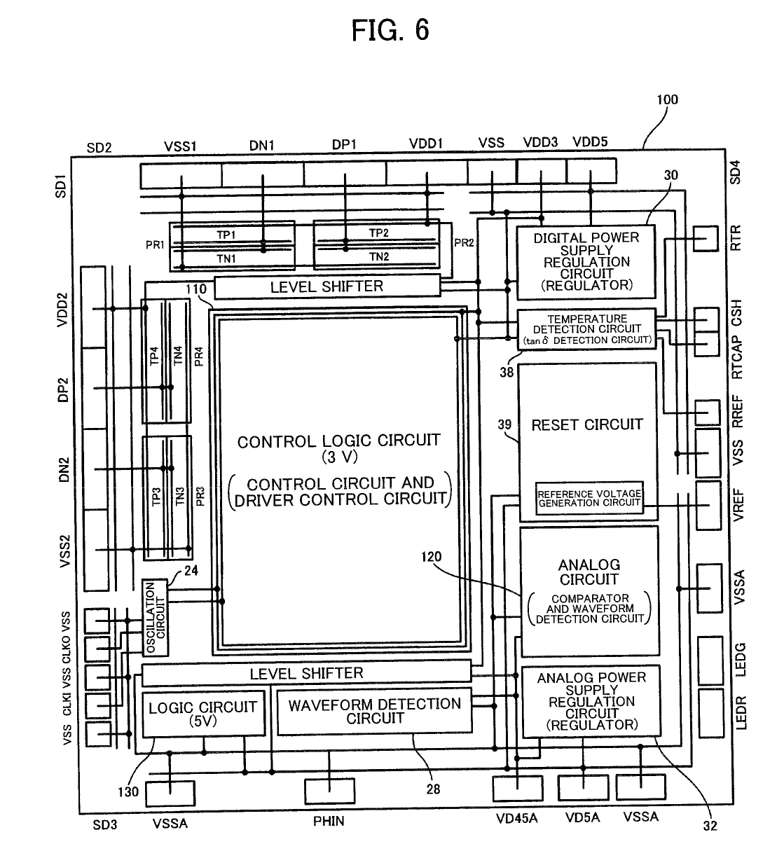

A control IC 100 shown in FIG. 6 includes the oscillation circuit 24, the waveform detection circuit 28, the temperature detection circuit 38 (see FIG. 2), a digital power supply regulation circuit 30, an analog power supply regulation circuit 32, a reset circuit 39, a control logic circuit 110, an analog circuit 120, and a logic circuit 130.

The control logic circuit 110 includes the power-transmission-side control circuit 22 and the driver control circuit 26 shown in FIG. 2. The control logic circuit 110 includes logic cells (e.g., NAND, NOR, inverter, and D flip-flop), and operates based on a digital power supply voltage VDD3 regulated by the digital power supply regulation circuit 30. The control logic circuit 110 may be implemented by a gate array, a microcomputer, or the like, and performs sequence control and a determination process. The control logic circuit 10 controls the entire control IC 100.

The digital power supply regulation circuit 30 (digital power supply regulator or digital constant voltage generation circuit) regulates a digital power supply (digital power supply voltage or logic power supply voltage). For example, the digital power supply regulation circuit 30 regulates a 5 V digital power supply voltage VDD5 input from the outside, and outputs a 3 V digital power supply voltage VDD3 at a stable potential.

The analog power supply regulation circuit 32 (analog power supply regulator or analog constant voltage generation circuit) regulates an analog power supply (analog power supply voltage). For example, the analog power supply regulation circuit 32 regulates a 5 V analog power supply voltage VD5A input from the outside, and outputs a 4.5 V analog power supply voltage VD45A at a stable potential.

The digital power supply regulation circuit 30 and the analog power supply regulation circuit 32 may be formed using a known series regulator, for example. The series regulator may include a driver transistor provided between a high-potential-side power supply and an output node, a voltage divider circuit that is provided between the output node and a low-potential-side power supply and divides an output voltage using resistors, and an operational amplifier, a reference voltage being input to a first input terminal (e.g., non-inverting input terminal) of the operational amplifier, the resistor-divided voltage from the voltage divider circuit being input to a second input terminal (e.g., inverting input terminal) of the operational amplifier, and an output terminal of the operational amplifier being connected to the gate of the driver transistor, for example. The analog power supply regulation circuit 32 may be a circuit that generates an analog GND voltage and supplies the analog GND voltage to the analog circuit 120.

The reset circuit 39 generates a reset signal, and output the reset signal to each circuit of the integrated circuit device. Specifically, the reset circuit 39 monitors a power supply voltage supplied from the outside, a digital power supply (logic power supply) voltage regulated by the digital power supply regulation circuit 30, and an analog power supply voltage regulated by the analog power supply regulation circuit 32. The reset circuit 39 cancels the reset signal when the power supply voltage has risen appropriately so that each circuit of the integrated circuit device starts operation to implement a power-on reset process.

The analog circuit 120 includes a comparator, an operational amplifier, and the like, and operates based on the analog power supply voltage VD45A regulated by the analog power supply regulation circuit 32. Specifically, the analog circuit 120 performs an analog process using one or more comparators and one or more operational amplifiers. More specifically, the analog circuit 120 may include a detection circuit that performs various detection processes such as amplitude detection (peak detection), pulse width detection, phase detection, and frequency detection, a determination circuit that performs a determination process using an analog voltage, an amplifier circuit that amplifies an analog signal, a current-mirror circuit, an A/D conversion circuit that converts an analog voltage into a digital voltage, and the like. The logic circuit 130 performs a digital process.

The control IC 100 is formed in the shape of a quadrangle, and has a first side SD1, a second side SD2, a third side SD3, and a fourth side SD4.

The control IC 100 includes predrivers PR1, PR2, PR3, and PR4. In FIG. 6, the predrivers PR1 and PR2 are disposed along the second side SD2 of the control IC 100, and the predrivers PR3 and PR4 are disposed along the first side SD1 adjacent to the second side SD2. The predrivers PR1, PR2, PR3, and PR4 are formed using complementary transistors (TP1 and TN1), (TP2 and TN2), (TP3 and TN3), and (TP4 and TN4).

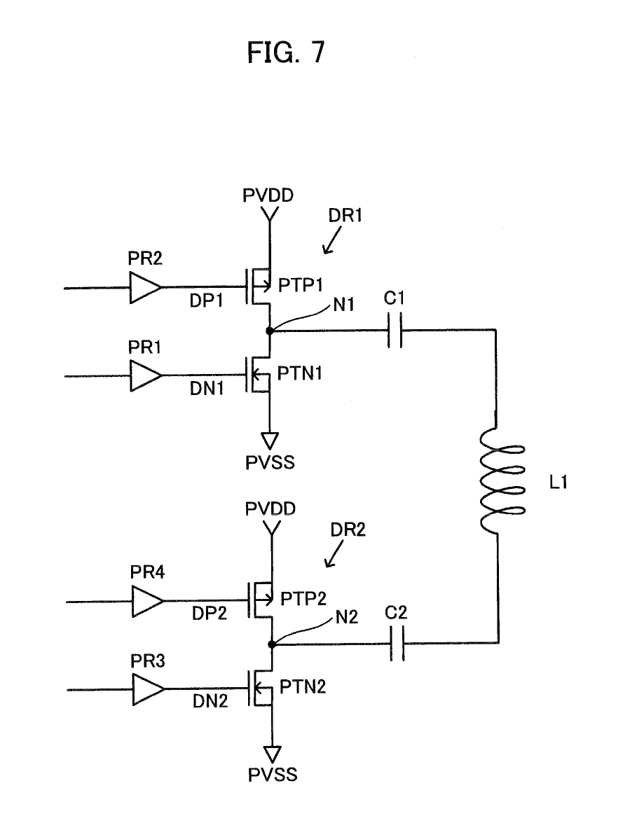

In FIG. 7, the first transmission driver DR1 is provided outside the control IC 100, for example. The first transmission driver DR1 includes an N-type power MOS transistor PTN1 (N-type transistor or N-type MOS transistor in a broad sense) and a P-type power MOS transistor PTP1 (P-type transistor or P-type MOS transistor in a broad sense) as external components. The first transmission driver DR1 may be a power transmission driver that drives a primary coil in non-contact power transmission, a motor driver that drives a motor, or the like.

The predriver PR1 drives the N-type power MOS transistor PTN1 of the first transmission driver DR1. Specifically, an inverter circuit that includes an N-type transistor and a P-type transistor may be used as the predriver PR1. A driver control signal DN1 from the predriver PR1 is input to the gate of the N-type power MOS transistor PTN1 through an output pad so that the transistor PTN1 is ON/OFF-controlled.

The predriver PR2 drives the P-type power MOS transistor PTP1 of the first transmission driver DR1. Specifically, an inverter circuit that includes an N-type transistor and a P-type transistor may be used as the predriver PR2. A driver control signal DP1 from the predriver PR2 is input to the gate of the P-type power MOS transistor PTP1 through an output pad so that the transistor PTP1 is ON/OFF-controlled.

The driver control signals DN1 and DP1 are non-overlap signals of which the active periods do not overlap. This prevents a situation in which a shoot-through current flows from the high-potential-side power supply to the low-potential-side power supply through the transistors.

The predrivers PR3 and PR4 drive transistors PTN2 and PTP2 of the second transmission driver DR2 shown in FIG. 7 based on driver control signals DN2 and DP2. The predrivers PR3 and PR4 operate in the same manner as the predrivers PR1 and PR2.

In FIG. 7, nodes N1 and N2 of the first and second transmission drivers DR1 and DR2 are connected to the ends of the primary coil L1 through the resonant capacitors C1 and C2. The resonant capacitors C1 and C2 form a series resonant circuit with the primary coil. Note that only one of the capacitors C1 and C2 may be provided.

The P-type power MOS transistor PTP1 and the N-type power MOS transistor PTN1 of the first transmission driver DR1 are connected in series between a power supply potential PVDD and a power ground power supply potential PVSS. Likewise, the P-type power MOS transistor PTP2 and the N-type power MOS transistor PTN2 of the second transmission driver DR2 are connected in series between the power power supply potential PVDD and the power ground power supply potential PVSS. Therefore, a large high-frequency analog alternating current flows through the primary coil L1, the first and second resonant capacitors C1 and C2, and the first and second transmission drivers DR1 and DR2 (power circuits) by controlling the first and second transmission drivers DR1 and DR2.

Various terminals are provided on the first side SD1, the second side SD2, the third side SD3, and the fourth side SD4 of the control IC 100 shown in FIG. 6. Output terminals for the driver control signals DN1 and DP1 are provided on the second side SD2, and output terminals for the driver control signals DN2 and DP2 are provided on the first side SD1. A terminal connected to the oscillation circuit 24 is provided on the first side SD1, and an input terminal of the induced voltage signal PHIN input to the waveform detection circuit 28 is provided on the third side SD3. A terminal of a temperature detection signal input to the temperature detection circuit 38 is provided on the fourth side SD4.

5. Structure of Coil Unit

The configuration of a coil unit 10 shown in FIG. 1 is described below with reference to FIGS. 8, 9A, and 9B.

FIG. 8 is an exploded oblique view showing the coil unit 10, FIG. 9A is an oblique view showing the coil unit 10 from the front surface, and FIG. 9B is an oblique view showing the coil unit 10 from the back surface.

In FIG. 8, the coil unit 10 includes a planar coil (primary coil L1) 430 that has a transmission surface 431 and a non-transmission surface 432, a magnetic sheet 440 provided on the side of the non-transmission surface 432 of the planar coil 430, and a heat sink/magnetic shield plate 450 stacked on the side of the magnetic sheet opposite to the side that faces the planar coil 430.

The planar coil 430 is not particularly limited insofar as the planar coil 30 is a flat (planar) coil. For example, a coil formed by winding a single-core or multi-core coated coil wire in a plane may be used as the planar coil 430. In this embodiment, the planar coil 430 has an air-core section 433 at the center. The planar coil 430 includes an inner end lead line 434 connected to the inner end of the spiral, and an outer end lead line 435 connected to the outer end of the spiral. In this embodiment, the inner end lead line 434 is provided toward the outside in the radial direction through the non-transmission surface 432 of the planar coil 430. This allows the transmission surface 431 of the planar coil 430 to be made flat so that the primary coil and the secondary coil are easily disposed adjacently when performing non-contact power transmission.

The magnetic sheet 440 disposed on the non-transmission surface 432 of the planar coil 430 is formed to have a size sufficient to cover the planar coil 430. The magnetic sheet 440 receives a magnetic flux from the planar coil 430, and increases the inductance of the planar coil 430. A soft magnetic material is preferably used as the material for the magnetic sheet 440. A soft magnetic ferrite material or a soft magnetic metal material may be used as the material for the magnetic sheet 440.

The heat sink/magnetic shield plate 450 is disposed on the side of the magnetic sheet 440 opposite to the side that faces the planar coil 430. The thickness of the heat sink/magnetic shield plate 450 is larger than that of the magnetic sheet 440. The heat sink/magnetic shield plate 450 has a function of a heat sink and a function of a magnetic shield which absorbs a magnetic flux which has not been absorbed by the magnetic sheet 440. As the material for the heat sink/magnetic shield plate 450, a non-magnetic material (i.e., a generic name for a diamagnetic material, a paramagnetic material, and an antiferromagnetic material) may be used. Aluminum or copper may be suitably used as the material for the heat sink/magnetic shield plate 450.

Heat generated by the planar coil 430 when a current is caused to flow through the planar coil 430 is dissipated utilizing solid heat conduction of the magnetic sheet 440 and the heat sink/magnetic shield plate 450 stacked on the planar coil 430. A magnetic flux which has not been absorbed by the magnetic sheet 440 is absorbed by the heat sink/magnetic shield plate 450. In this case, the heat sink/magnetic shield plate 450 inductively heated by a magnetic flux which has not been absorbed by the magnetic sheet 440. However, since the heat sink/magnetic shield plate 450 has a given thickness, the heat sink/magnetic shield plate 450 has a relatively large heat capacity and a low heat generation temperature. Moreover, the heat sink/magnetic shield plate 450 easily dissipates heat due to its dissipation characteristics. Therefore, heat generated by the planar coil 430 can be efficiently dissipated. In this embodiment, the total thickness of the planar coil 430, the magnetic sheet 440, and the heat sink/magnetic shield plate 450 can be reduced to about 1.65 mm.

In this embodiment, a spacer member 460 having a thickness substantially equal to the thickness of the inner end lead line 434 is provided between the planar coil 430 and the magnetic sheet 440. The spacer member 460 is formed in the shape of a circle having almost the same diameter as that of the planar coil 430, and has a slit 462 positioned to avoid at least the inner end lead line 434. The spacer member 460 is a double-sided adhesive sheet, for example. The spacer member 460 bonds the planar coil 430 to the magnetic sheet 440.

In this embodiment, although the non-transmission surface 432 of the planar coil 430 protrudes corresponding to the inner end lead line 434, the non-transmission surface 432 of the planar coil 430 can be made flat and caused to adhere to the magnetic sheet 440 using the spacer member 460. The heat transfer properties can thus be maintained.

In this embodiment, the coil unit 10 includes a substrate 490 on which the heat sink/magnetic shield plate 450 is secured. In this case, the heat sink/magnetic shield plate 450 dissipates heat to the substrate 490. The substrate 490 has coil connection pads 493 to which the inner end lead line 434 and the outer end lead line 435 of the planar coil 430 are connected.

The coil unit 10 includes a protective sheet 470 that covers each end of the magnetic sheet 440 and the heat sink/magnetic shield plate 450 and bonds the magnetic sheet 440 and the heat sink/magnetic shield plate 450 to a surface 491 of the substrate 490. In this case, the inner end lead line 434 and the outer end lead line 435 of the planar coil 430 are connected to the coil connection pads 493 of the substrate 490 to pass over the protective sheet 470. The protective sheet 470 has a hole 471 that accommodates the planar coil 430. The protective sheet 470 also functions as a covering member that covers the end of the magnetic sheet 440. The end of the magnetic sheet 440 is fragile and is easily removed. However, the material of the end of the magnetic sheet 440 can be prevented from being removed by covering the end of the magnetic sheet 440 with the protective sheet 470 (i.e., covering member). The covering member may be formed of a sealing member such as silicon instead of the protective sheet 470.

In this embodiment, as shown in FIG. 9B, the coil unit 10 includes a temperature detection element 480 (first thermistor RT0) that is provided on a back surface 492 of the substrate 490 and detects the temperature of heat generated by the planar coil 430 and transferred through solid heat conduction of the magnetic sheet 440 and the heat sink/magnetic shield plate 450, for example. Even if a foreign object or the like has been inserted between the primary coil and the secondary coil and so that the temperature of the primary-side planar coil 430 has abnormally increased as compared with the ambient temperature, the abnormality can be detected by the temperature detection element 480. When an abnormality in temperature of the planar coil 430 has been detected by the temperature detection element 480, power transmission may be stopped by a control circuit provided in the control IC. This makes it possible to prevents a current from flowing through the planar coil 430 when the temperature of the heat sink/magnetic shield plate has abnormally increased due to an increase in temperature of the planar coil 430 due to insertion of a foreign object or the like.

In the embodiment shown in FIGS. 8 to 13, the first thermistor RT1 that detects the temperature of the resonant capacitor (C1 or C2) shown in FIG. 2 is not provided. Specifically, since the resonant capacitor C2 is a ceramic capacitor in the embodiment shown in FIGS. 8 to 12, the temperature of the resonant capacitor C2 does not easily increase as compared with a film capacitor. In the embodiment shown in FIGS. 8 to 13, the temperature of the primary coil L1 is measured by the first thermistor RT0, the ambient temperature is measured by the second thermistor RT2, and an abnormality in power transmission is detected from the difference between the temperature of the primary coil L1 and the ambient temperature. The above-described tan δ detection circuit 38 may be further provided, or only the tan δ detection circuit 38 may be provided.

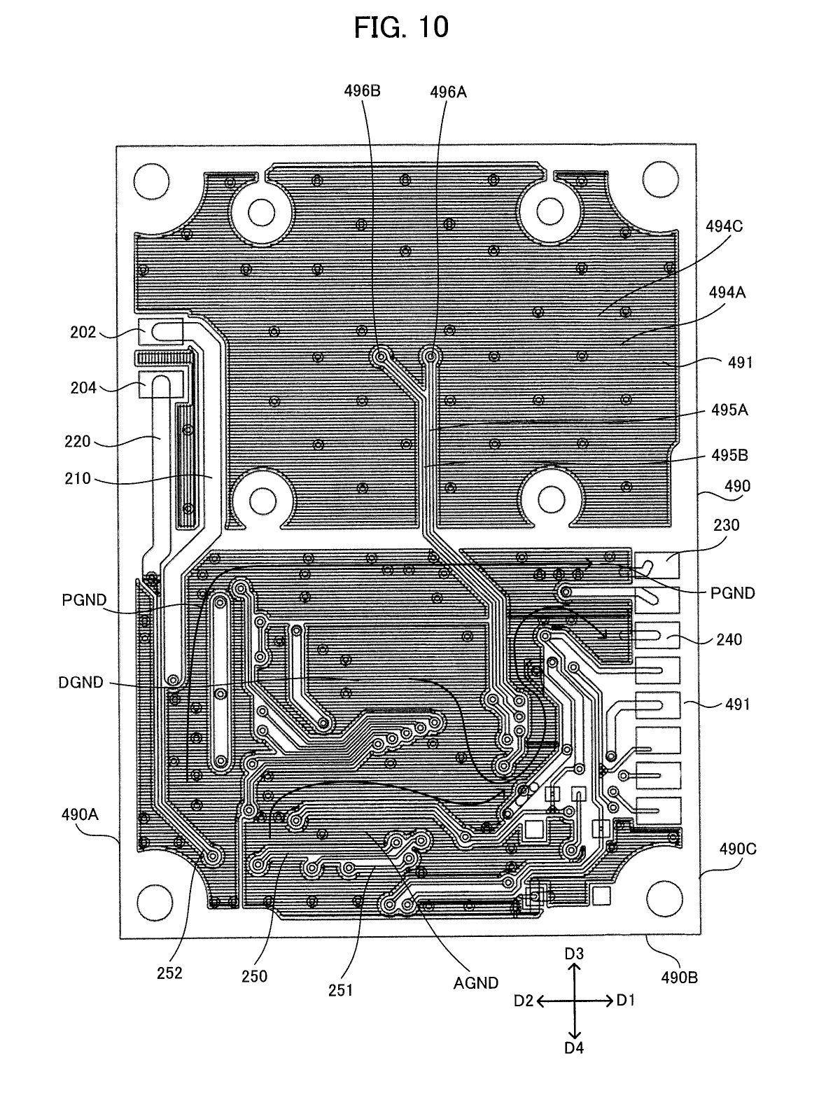

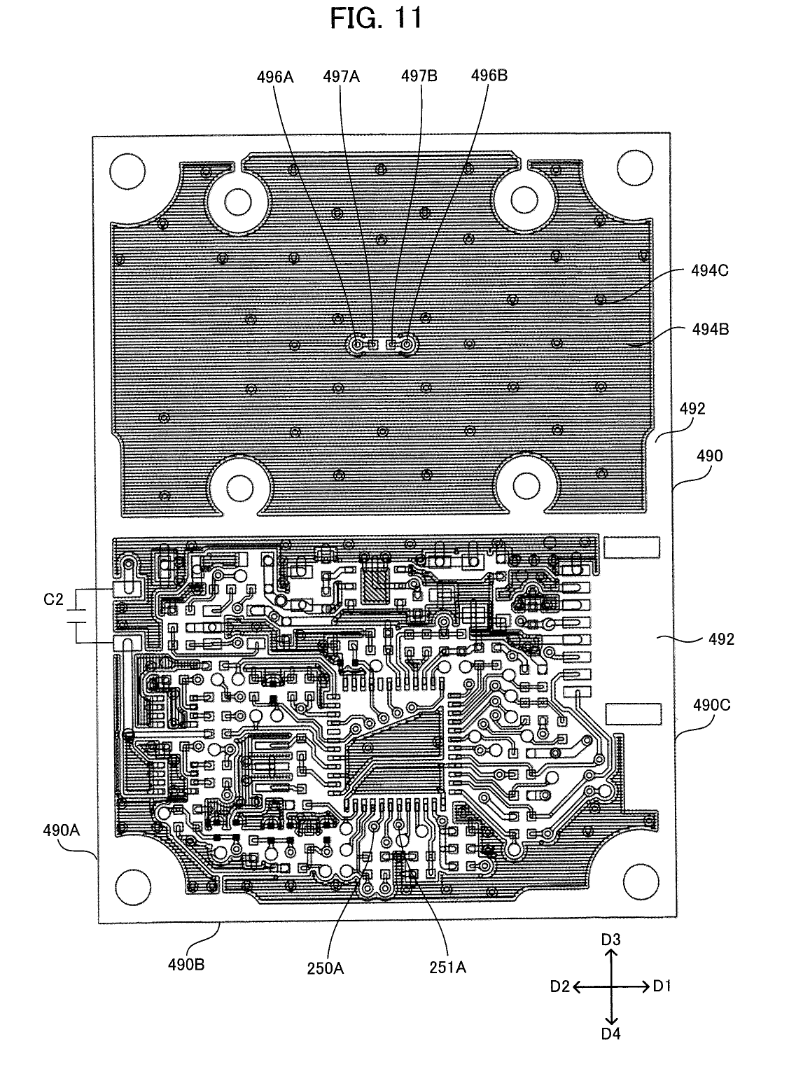

FIG. 10 is a wiring pattern diagram showing the front surface 491 of the substrate 490, and FIG. 11 is a wiring pattern diagram showing the back surface 492 of the substrate 490. As shown in FIGS. 10 and 11, heat transfer conductive patterns 494A and 494B are formed on the front surface 491 and the back surface 492 of the substrate 490 over almost the entire area that faces the heat sink/magnetic shield plate 450. The heat transfer conductive patterns 494A and 494B on the front surface 491 and the back surface 492 of the substrate 490 are connected via a plurality of through-holes 494C.

Thermistor wiring patterns 495A and 495B insulated from the heat sink/magnetic shield plate 450 and the heat transfer conductive pattern 494A are formed on the front surface 491 of the substrate 490 shown in FIG. 10. The thermistor wiring patterns 495A and 495B are connected to thermistor connection patterns 497A and 497B formed on the back surface 102 of the substrate 100 shown in FIG. 11 via two through-holes 496A and 496B. The thermistor connection patterns 497A and 497B are insulated from the heat transfer conductive pattern 494B.

According to this configuration, heat generated by the planar coil 430 is transferred to the temperature detection element 40 (omitted in FIG. 11) through solid heat conduction of the magnetic sheet 440, the heat sink/magnetic shield plate 450, the heat transfer conductive pattern 494A on the front surface 491 of the substrate 490, the through-hole 494C, and the heat transfer conductive pattern 494B on the back surface 492 of the substrate 490. Moreover, the temperature detection element 480 does not interfere with the heat sink/magnetic shield plate 450 by providing the temperature detection element 480 on the back surface 491 of the substrate 490.

6. Layout of Main Components on Mounting Surface of Substrate

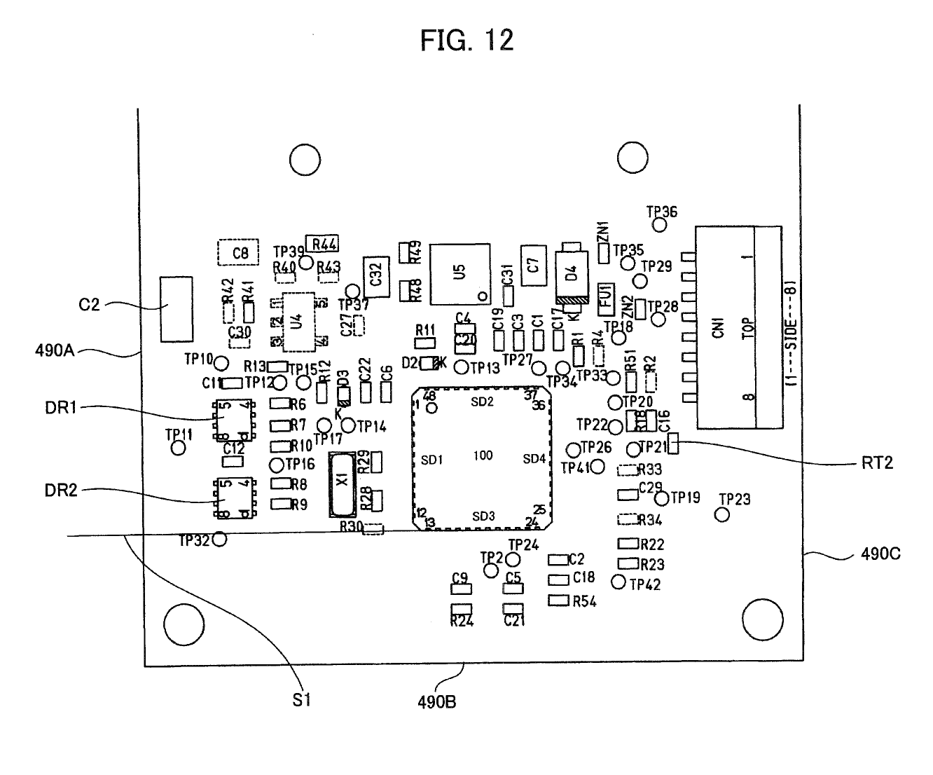

FIG. 12 shows the main components disposed on a mounting surface 492A of the substrate 490 of the power transmission device 10. In FIGS. 10 to 12, the rightward direction (e.g., first direction) is referred to as D1, the leftward direction (e.g., second direction) is referred to as D2, the upward direction is referred to as D3, and the downward direction is referred to as D4. In FIGS. 10 to 12, three sides of the substrate 490 are referred to as a first substrate side 490A, a second substrate side 490B, and a third substrate side 490C.

In FIG. 10, coil connection terminals 202 and 204 to which either end of the primary coil L1 is connected are provided.

The control IC 100 is disposed almost at the center of the mounting area of the substrate 490 in the direction D4. As shown in FIG. 12, the control IC 100 is formed almost in the shape of a square having the first side SD1, the second side SD2, the third side SD3, and the fourth side SD4, and has 48 pins in total on the four sides. The pin provided on the end of the first side SD1 in the direction D3 has a pin number 1. The pin number increases counter-clockwise, and the pin provided on the end of the Direction D3 in the direction D2 has a pin number 48.

The resonant capacitor C2 is provided as a resonant capacitor that forms a series resonant circuit with the primary coil CL1. The capacitor C1 shown in FIGS. 4 and 7 is not provided in the embodiment shown in FIGS. 10 to 12.

The first and second power transmission drivers DR1 and DR2 that drive the primary coil L1 from either end of the primary coil L1 through the coil connection terminals 202 and 204 are disposed in an area between a side 490A of the substrate parallel to the first side SD1 of the control IC 100 and the control IC 100 together with the resonant capacitor C2.

The thermistor RT2 that measures the ambient temperature is disposed in the fourth direction D4 with respect to the fourth side SD4 of the control IC 100.

An oscillator X1 supplied a reference clock signal to the oscillation circuit 24 of the control IC 100 shown in FIG. 6. The oscillator X1 is disposed between the first side SD1 of the control IC 100 and the first and second power transmission drivers DR1 and DR2.

7. Layout of Wiring Pattern on Mounting Surface of Substrate

FIG. 11 shows a wiring pattern on the mounting surface 492 of the substrate 490. Wide patterns 210 and 220 are respectively connected to the coil connection terminals 202 and 204 of the non-mounting surface 491 shown in FIG. 10. The wide pattern 210 is connected to the first transmission driver DR1 shown in FIG. 12 via a through-hole. The wide pattern 220 is connected to the second transmission driver DR2 shown in FIG. 12 via the resonant capacitor C2 shown in FIG. 11. The second wide pattern 220 is also used as part of a waveform detection wiring pattern for the waveform detection signal PHIN.

The gates of the transistors PTP1 and PTN1 (see FIG. 7) of the first transmission driver DR1 are connected to the pins 4, 6, 43, and 45 of the control IC 100.

As described above, the wide patterns 210 and 220, the resonant capacitor C2, and the first and second transmission drivers DR1 and DR2 connected to the coil connection terminals 202 and 204 are disposed on (along) the side 490A of the substrate 490. The power circuits (primary coil CL1, resonant capacitor C2, and first and second transmission drivers DR1 and DR2) that require a large amount of high-frequency power (e.g., about several hundreds of mA to 1 A at 5 V) are thus collectively disposed on the first substrate side 490A (i.e., a position shifted in the second direction DR2). As a result, a path for a large current that flows through the power circuits can be collectively provided on the first substrate side 490A (preferably an area in the direction D3 with respect to an extension S1 of the third side SD3 of the control IC 100 shown in FIG. 12). Moreover, since the power components are disposed adjacently, a current loss can be reduced.

It is necessary to input the waveform detection signal PHIN to the input terminals (pin numbers 17 and 18) provided on the third side SD3 of the control IC 100 from the coil connection terminal 204 of the primary coil L1, as described above. Since the waveform detection signal PHIN is a small analog signal with a current of several tens of mA at a voltage of 5 V, it is necessary to prevent interference between the waveform detection signal PHIN and a large analog current.

In this embodiment, waveform voltage detection patterns (narrow patterns) 250 to 252 (see FIG. 10) through which the waveform detection signal PHIN is transmitted are connected to through-holes 250A and 251A of patterns connected to the input terminals (pin numbers 17 and 18) provided on the third side SD3 of the control IC 100. The waveform voltage detection pattern (narrow pattern) 252 is connected to the coil connection terminal 204 of the primary coil L1 through the wide pattern 220.

Since the waveform voltage detection patterns (narrow patterns) 250 to 252 (see FIG. 10) are disposed in an area that is shifted in the direction D4 with respect to the extension S1 shown in FIG. 12 and is positioned along the second substrate side 489B, a large analog current and a current synchronized with a large analog current do not flow in that area so that noise is rarely superimposed on the waveform detection signal PHIN.

A wire connected to the thermistor (first thermistor) 480 (RT0) that measures the temperature of the planar coil CL1 is connected to the pin 31 provided on the fourth side SD4 of the control IC 100 through the wiring pattern on the front surface and the back surface of the substrate 490. The thermistor (second thermistor) RT2 that measures the ambient temperature is connected to the pin 36 provided on the fourth side SD4 of the control IC 100.

Since the second thermistor RT2 is disposed to face the fourth side SD4 of the control IC 100, the wiring pattern connected to the second thermistor RT2 can be easily provided.

The oscillator X1 shown in FIG. 12 is connected to the pins 9 and 11 provided on the first side SD1 of the control IC 100. Since the reference clock signal from the oscillator X1206 is synchronized with a current supplied to the first and second transmission drivers DR1 and DR2, an adverse effect due to a large analog current occurs to only a small extent.

It is preferable that the oscillator X1 be disposed at a first corner side of the control IC 100 shown in FIGS. 9 and 12 where the first side SD1 intersects the third side SD3. According to this configuration, a power supply component CN1 (see FIG. 12) disposed at a second corner side of the control IC 100 where the second side SD2 intersects the fourth side SD4 faces the oscillator X1 across the control IC 100. This reduces an adverse effect (e.g., noise) of the oscillator X1 on the power supply component CN1 and a power supply voltage supplied from the power supply component CN1 to the control IC 100.

8. Power Supply Pattern of Substrate

As shown in FIG. 10, power supply patterns are provided on the non-mounting surface 491 of the substrate 490 opposite to the mounting surface 492 in addition to the above-mentioned signal wiring patterns. FIG. 10 is a perspective view through the mounting surface 492 shown in FIG. 9. For example, the right end of the mounting surface 492 shown in FIG. 9 is opposite to the right end of the non-mounting surface 491 shown in FIG. 10. In FIGS. 9 and 10, a double circle indicates a through-hole. The power supply patterns shown in FIG. 10 are connected to power supply patterns on the mounting surface 492 shown in FIG. 9.

A power ground power supply pattern PGND connected to the first and second power transmission drivers an analog ground power supply pattern AGND connected to the power supply terminal group of the control IC 100, and a digital ground power supply pattern DGND are provided as ground (GND) power supply patterns.

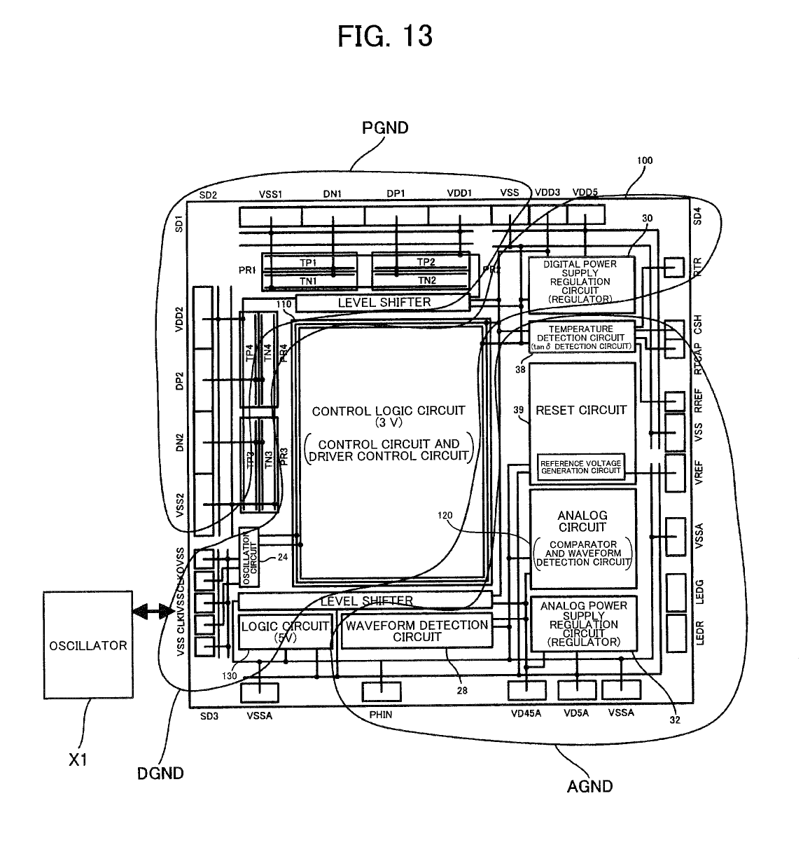

The power ground power supply pattern PGND, the analog ground power supply pattern AGND, and the digital ground power supply pattern DGND schematically shown in FIG. 13 are provided in the control IC 100.

The power ground power supply pattern PGND shown in FIG. 10 is connected to the analog ground power supply pattern AGND and the digital ground power supply pattern DGND only in the area of ground terminals 230 and 240 provided on the third substrate side 490C parallel to the fourth side SD4 of the control IC 100. The analog ground power supply pattern AGND and the digital ground power supply pattern DGND are connected before reaching the ground terminal 240.

The analog ground power supply pattern AGND is formed in an area that faces at least part of the control IC 100 and the waveform detection wiring patterns (narrow patterns) 250 to 252. The power ground power supply pattern PGND is formed in an area that is formed along the first substrate side 490A, extends in the third direction D3, and extends toward the ground power supply terminal 230 on the third substrate side 490C in the first direction.

Specifically, the power ground power supply pattern PGND is provided from an area of the non-mounting surface 491 that is the back surface opposite to an area in which the resonant capacitor C2 and the first and second power transmission drivers DR1 and the DR2 are provided, passes through an area of the non-mounting surface 491 that is the back surface opposite to an area opposite to the narrow patterns 250 to 251 across the control IC 100, and is connected to the ground terminal 230 provided on the third substrate side 490C. The digital ground power supply pattern DGND is connected to the ground power supply pattern AGND from the vicinity of the back surface of the control IC 100, bypasses the thermistor wiring patterns 495A and 495B, and extends toward the ground power supply terminal 240 provided on the third substrate side 490C.

Since a current that flows through the power ground power supply pattern PGND does not flow through the area opposite to the waveform detection wiring pattern for the waveform detection signal PHIN, an effect of a large analog current on the waveform detection signal PHIN can be reduced.

As shown in FIGS. 12 and 13, the oscillator X1 is disposed near the first corner of the control IC 100 where the first side SD1 intersects the third side SD3. According to this configuration, the power supply component CN1 disposed near the second corner of the control IC 100 where the second side SD2 intersects the fourth side SD4 faces the oscillator X1 across the control IC 100. This reduces an adverse effect (e.g., noise) of the oscillator X1 on the power supply component CN1 and a power supply voltage supplied from the power supply component CN1 to the control IC 100.

Although the embodiments of the invention have been described in detail above, those skilled in the art would readily appreciate that many modifications are possible in the embodiments without materially departing from the novel teachings and advantages of the invention. Accordingly, such modifications are intended to be included within the scope of the invention. Any term cited with a different term having a broader meaning or the same meaning at least once in the specification and the drawings can be replaced by the different term in any place in the specification and the drawings. The invention also includes any combination of the embodiments and the modifications.

What is claimed is:

1. A power transmission device that includes a primary coil and electromagnetically couples the primary coil with a secondary coil of a power reception device to supply power to a load of the power reception device, the power transmission device comprising:
coil connection terminals respectively connected to ends of the primary coil;
a resonant capacitor that forms a series resonant circuit with the primary coil;
a first power transmission driver and a second power transmission driver that drive the primary coil from the ends of the primary coil through the coil connection terminals; and
a control IC that outputs driver control signals to the first power transmission driver and the second power transmission driver,
the coil connection terminals, the resonant capacitor, the first power transmission driver, the second power transmission driver, and the control IC being provided on a substrate;
the control IC being formed in the shape of a quadrangle that has a first side, a second side, a third side, and a fourth side, a first output terminal that outputs the driver control signal to the first transmission driver being provided adjacent to the first side, a second output terminal that outputs the driver control signal to the second transmission driver being provided adjacent to the second side crossing the first side, and an input terminal that receives a signal waveform at one of the coil connection terminals through a waveform detection wiring pattern being disposed adjacent to the third side opposite to the second side;
the resonant capacitor, the first power transmission driver, and the second power transmission driver being disposed between a first substrate side and the control IC, the first substrate side being parallel to the first side of the control IC; and
the waveform detection wiring pattern extending in an area between a second substrate side parallel to the third side of the control IC and an extension of the third side of the control IC and being connected to one of the coil connection terminals.

2. The power transmission device as defined in claim 1,
the resonant capacitor, the first power transmission driver, and the second power transmission driver being disposed at a position shifted to the control IC side of the extension of the third side of the control IC.

3. The power transmission device as defined in claim 1,
the waveform detection wiring pattern including a wide pattern that is formed along the first substrate side and connected to one of the coil connection terminals, and a narrow pattern that is formed along the first substrate side and connected to the input terminal provided on the third side of the control IC.

4. The power transmission device as defined in claim 3,
the power transmission device including power supply patterns provided on a non-mounting surface of the substrate, the non-mounting surface being a back surface of a mounting surface provided with the control IC,
the power supply patterns including:
a power ground power supply pattern connected to the first power transmission driver and the second power transmission driver; and
an analog ground power supply pattern and a digital ground power supply pattern connected to power supply terminals of the control IC; and
the power ground power supply pattern being connected to the analog ground power supply pattern and the digital ground power supply pattern only in an area of a ground terminal provided on a third substrate side parallel to the fourth side of the control IC.

5. The power transmission device as defined in claim 4,
the power ground power supply pattern being provided from a first area of the non-mounting surface that is the back surface opposite to a second area where the resonant capacitor, the first power transmission driver, and the second power transmission driver are provided, passing through a third area of the non-mounting surface that is the back surface opposite to a fourth area opposite to the narrow pattern across the control IC, and being connected to the ground terminal provided on the third substrate side.

6. The power transmission device as defined in claim 1,
the power transmission device including an oscillator that is provided on a mounting surface of the substrate and connected to a terminal provided on the first side of the control IC, the oscillator being provided between the first power transmission driver and the first side of the control IC and between the second power transmission driver and the first side of the control IC.

7. The power transmission device as defined in claim 6,
the oscillator being disposed at a first corner side of the control IC, the first corner side including a corner where the first side intersects the third side; and
a power supply component disposed at a second corner side of the control IC, the second corner side including a corner where the second side intersects the fourth side.

8. The power transmission device as defined in claim 1,
the power transmission device further including a first thermistor that detects a temperature of the primary coil, and a second thermistor that detects an ambient temperature,
the control IC including a temperature detection circuit that calculates a difference between the temperature of the primary coil from the first thermistor and the ambient temperature from the second thermistor.

9. The power transmission device as defined in claim 1,
the power transmission device further including a first thermistor that detects a temperature of the primary coil, and a second thermistor that detects an ambient temperature,
the control IC including a temperature detection circuit that detects an abnormality of tan δ of the resonant capacitor by calculating a difference between the temperature of the primary coil from the first thermistor and the ambient temperature from the second thermistor.

10. The power transmission device as defined in claim 8,
the control IC including a control circuit that stops power transmission using the first power transmission driver and the second power transmission driver when the temperature detection circuit has detected an abnormality in temperature.

11. An electronic instrument comprising the power transmission device as defined in claim 1.
